(19) United States
(12) Patent Application Publication
(10) Pub. No.: US 2009/0088960 A1
(43) Pub. Date: Apr. 2, 2009

(54) Method for Displaying the Consumption of an Operating Material and/or Pollutant Emissions of a Vehicle and Display Device

(75) Inventor: Winfried Moll, Laubach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/240,480

(22) Filed: Sep. 29, 2008

(30) Foreign Application Priority Data
Sep. 28, 2007 (DE) 10 2007 046 970.7
Sep. 5, 2008 (DE) 10 2008 045 811.2

(51) Int. Cl. G06G 7/70

(52) U.S. Cl. 701/123

(57) ABSTRACT

To assist the driver of a vehicle in driving the vehicle in an improved, environmentally conscious way, a first consumption profile of a first predetermined instantaneous consumption and/or pollutant emissions over a predefined route is displayed on the display device, and at the same time a second consumption profile of an actual instantaneous consumption over a route section of the predefined route that has been traveled along by the vehicle, is displayed on the display device. Furthermore, it is proposed that a first pollutant emission profile of a first predetermined instantaneous amount of pollutant emissions over the predefined route is displayed on the display device and at the same time a second pollutant emission profile of an actual instantaneous amount of pollutant emissions over the route section traveled along by the vehicle, of the predefined route is displayed on the display device.

### BACKGROUND OF THE INVENTION

1. Field of the Invention

Disclosed is a method for graphically displaying operating material consumption, in particular fuel consumption of a motor vehicle by a display device and a method for graphically displaying pollutant emissions of a vehicle, in particular a motor vehicle, by a display device, and a display device for carrying out at least one of the abovementioned methods.

2. Description of the Related Art

A motor vehicle is known that has a combination display instrument with an analog consumption display instrument and a screen display which serves to provide an alphanumeric character display. An instantaneous fuel consumption of the motor vehicle is displayed to a driver of the vehicle by the consumption display instrument. After a route has been traveled, a standardized average consumption over the route can be displayed in the form of a decimal fraction of the screen display. A disadvantage of this prior art configuration is that only the instantaneous fuel consumption is continuously displayed and subsequently and under certain circumstances, the average consumption is conveyed to the driver. A differentiated overview of the consumption behavior of the motor vehicle is not provided here, with the result that it is difficult for the driver of the vehicle to adapt his driving style in a continuously targeted fashion to optimize fuel consumption and be as environmentally friendly as possible.

### SUMMARY OF THE INVENTION

An object of the invention is to provide a method that permits a driver of a vehicle to drive the vehicle in an improved, environmentally conscious way by providing a display device for graphically displaying the consumption of an operating material and for graphically displaying the pollutant emissions of the vehicle.

According to one embodiment of the invention, a first consumption profile of a first predetermined instantaneous consumption over a predefined route is displayed on the display device, and at the same time, a second consumption profile of an actual instantaneous profile over a route section of the predefined route traveled along by the vehicle, is displayed on the display device.

According to one embodiment of the invention, a first pollutant emission profile of a first predetermined instantaneous amount of pollutant emissions over a predefined route is displayed on the display device and at the same time a second pollutant emission profile of an actual instantaneous amount of pollutant emissions over a route section, traveled by the vehicle, is displayed on the display device.

According to one embodiment of the invention, the first consumption profile and/or the first pollutant emission profile are displayed continuously and are displayed before the entire predefined route has been traveled along or only part of the route has been traveled. The driver of the vehicle is therefore able to continuously adapt his driving style so that the actual instantaneous consumption and/or the actual instantaneous amount of pollutant emissions reaches a value which is below the first consumption profile or respectively below the first pollutant emission profile. It is comparable to a sport-like challenge, for the driver to try to counteract the first predetermined profile curves with the objective of remaining below them, as a result of which the vehicle driver's competitive spirit is continuously spurred and a continuously optimized driving style, in terms of the lowest possible loading of the environment, can advantageously be achieved.

It is preferable that the first consumption profile and/or the first pollutant emission profile, which are typically embodied as curves, are oriented according to the actual conditions on the route; therefore not only the length of the predefined route is considered but also, for example, the route profile (for example a route with many bends or few bends) and/or the route gradient profile (for example many gradients or few gradients, degree of positive and negative gradients) and/or the road profile (for example proportions of the road profile which are within built-up areas and those outside built-up areas) and/or the type of road (for example secondary roads or freeways). As a result, the first consumption profile and/or the first pollutant emission profile in the form of curves are obtained and provide qualified information about the instantaneous consumption or instantaneous amount of pollutant emissions which are to be respectively expected at a particular point on the route. These can be used by the driver of the vehicle as a measure of his driving behavior.

The various profiles in the form of curves can be displayed, in a planar fashion or as a line diagram. The display can be monochrome or in color. The invention preferably produces an environmental balance of the actual amount of pollutant emissions compared to a predetermined amount of pollutant emissions. It is also advantageous that by virtue of comparison possibilities, value deviations of the vehicle that have an influence on the consumption of operating material or the pollutant emissions, such as the tire pressure or engine setting, can be detected early for a specific predefined route which is repeatedly traveled. Both the consumption of operating material, fuel, and the pollutant emissions are a characteristic variable of loading of the environment or environmental protection. The operating material can be any kind of energy carriers used to power a vehicle, such as fuel in a vehicle driven by an internal combustion engine e.g., gasoline, diesel fuel, hydrogen, or the like, or electrical energy in a vehicle that is driven by an electric motor. Pollutant emissions may be, for example, carbon dioxide (CO₂) emissions, nitrogen oxide (NOₓ) emissions, carbon monoxide (CO) emissions, soot (carbon particles) emissions, or the like.

In one embodiment the invention co-operates with an engine control system of a motor vehicle such that the power of a drive motor of the motor vehicle is reduced by the engine controller in a way which is adapted to the driver's driving style of the vehicle and is expected on the basis of the actual instantaneous consumption compared to the predetermined instantaneous consumption or the actual instantaneous amount of pollutant emissions compared to the predetermined instantaneous amount of pollutant emissions. For this purpose, the engine controller may for example, switch into a correspondingly adapted engine operating mode which is particularly environmentally friendly.

According to one embodiment of the method, which relates to the consumption of operating material, the instantaneous consumption over the predefined route is predetermined taking into account a selected travel time for the predefined route. By specifying the selected travel time, which, for example, can be input manually by the driver of the vehicle into the display device and can also be expressed, for example, by a desired arrival time at the destination, at the end of the predefined route, the first consumption profile can be adapted in such a way that optimization of the time/consumption is calculated and a corresponding new first consumption profile is displayed.

According to another embodiment of the invention a third consumption profile of a second predetermined instantaneous consumption over at least a first partial route of the residual route section, still to be traveled along by the vehicle, of the predefined route is displayed taking into account the actual instantaneous consumption over the already traveled section of the predefined route. In this way, the curve of the actual instantaneous consumption is continued into the future, in a way which takes into account the driving style and temporary environmental influences which increase the consumption of operating material such as, for example severe cold, precipitation, or darkness.

According to another embodiment of the invention, the predefined route and the consumption profile of the actual instantaneous consumption over the predefined route is stored in a memory. If the same route is traveled along relatively frequently, there is the possibility of making comparisons, both for the driver of the vehicle and/or for different drivers of the vehicle.

To make simple, easily understood comparisons between different drivers of vehicles, according to another embodiment of the invention, after the entire predefined route has been traveled, an average consumption over the predefined route is acquired and is stored in the memory unit. Data relating to the consumption of operating material is stored so that it can be used to produce a ranking of different journeys and/or different drivers of the vehicle with respect to specific predefined routes. The rankings can preferably be called and displayed on the display device.

For an environmentally friendly driving style, according to one embodiment of the invention, a velocity of the vehicle and/or a gear speed of a vehicle transmission of the vehicle to achieve the predetermined instantaneous consumption is acquired taking into account the actual instantaneous consumption.

According to one embodiment of the method which relates to pollutant emissions, the instantaneous amount of pollutant emissions over the predetermined route is predetermined by taking into account a selected travel time for the predefined route. The selected travel time may be input manually by the driver of the vehicle into the display device may alternatively be expressed by a desired arrival time at the destination, i.e., the end of the predefined route. The first pollutant emission profile can be adapted by specifying the selected travel time such that optimization of the time/pollutant emissions can be calculated and a corresponding new first pollutant emission profile is displayed.

A further improved way of providing assistance for environmentally conscious and environmentally friendly driving is provided for the driver of the vehicle. According to another embodiment of the invention, a third pollutant emission profile of a second predetermined instantaneous amount of pollutant emissions over at least a first partial route of the residual route section of the predefined route still to be traveled along by the vehicle is displayed taking into account the actual instantaneous amount of pollutant emissions over the traveled-along route section of the predefined route. In this way, the curve of the actual instantaneous amount of pollutant emissions is continued into the future in a way which takes into account the driving style and the temporary environmental influences which can increase the pollutant emissions such as, for example, severe cold, precipitation, or darkness.

According to another embodiment of the invention, the predefined route and the pollutant emission profile of the actual instantaneous amount of pollutant emissions over the predefined route are stored in a memory unit. If the same route is traveled along relatively frequently, it is possible to make comparisons, both for the driver of the vehicle and/or for different drivers of the vehicle.

A possible way of making comparisons, in particular between different drivers of a vehicle, which is simple and easy to understand includes acquiring and storing, the entire amount of pollutant emissions over the predefined route in the memory unit after the entire predefined route has been traveled along. With the data relating to the pollutant emissions which are stored in this way, it is possible to produce a ranking of different journeys and/or different drivers of the vehicle with respect to specific, predefined routes, and to call said data and display it on the display device.

According to another embodiment of the invention, a necessary velocity of the vehicle and/or a necessary gear speed of a vehicle transmission of the vehicle to reach the predetermined instantaneous amount of pollutant emissions are/is acquired taking into account the actual instantaneous amount of pollutant emissions.

In one embodiment of the invention, there is a linear relationship between the consumption of the operating material and the pollutant emissions of the vehicle. In such a case, the qualitative information which the driver of the vehicle can obtain from the consumption profile corresponds to the information that he can obtain from the pollutant emission profile. If such a relationship does not exist, it is advantageous for providing comprehensive assistance for the driver of the vehicle to display the first and second consumption profiles and the first and second pollutant emission profiles are simultaneously.

According to another embodiment of the invention, the acquired velocity and/or the acquired gear speed are transmitted to a driver of the vehicle by means of an output device. It is conceivable the acquired velocity or the acquired gear speed could to be set automatically, but the acquired values are preferably transmitted to the driver of the vehicle, with the result that it is at the driver's discretion whether to comply with such an indication and reduce the velocity or, to refrain from complying with the indication owing to the traffic situation which is actually present. The transmission of acquired velocity and/or gear speed way occur, for example, acoustically using a voice output device, but it preferably occurs visually by displaying the acquired values on the display device.

According to one embodiment of the invention, the predefined route is determined by means of a navigation device, preferably using GPS, with the result that the driver of the vehicle only needs to enter the necessary destination for the route into the navigation device in a simple manner.

According to another embodiment of the invention, the predefined route and/or the first consumption profile over the predefined route are determined by recording the route and/or the consumption profile when the vehicle travels along the route. The route is preferably stored in the memory unit. As a result, the method according to one embodiment can be carried out in a particularly operation-friendly way, and independent of other devices, such as a navigation device.

A method which is particularly convenient for the driver of a vehicle can be achieved in that according to an embodiment of the invention includes driving to the acquired velocity to serve as an input signal of a velocity control system, i.e., cruise control, and the velocity control system controls the velocity of the vehicle as a function of this input signal.

A system according to one embodiment of the invention includes a display device, a memory unit in which the first consumption profile and/or the first pollutant emission profile is stored, a first sensor device for sensing an instantaneous consumption, and/or a second sensor device for sensing an instantaneous amount of pollutant emissions and an evaluation unit for determining the second consumption profile from the sensed instantaneous consumption and/or the second pollutant emission profile from the sensed instantaneous amount of pollutant emissions are provided.

The display device according to an embodiment of invention comprises a combination display instrument for a motor vehicle that processes sensor data of the first and/or second sensor devices, determines the actual consumption or the actual emission of pollutants, and displays the acquired values for consumption or the emission of pollutants together with the first consumption profile which is stored in a memory or the first pollutant emission profile. The sensing of the instantaneous consumption and/or the sensing of the instantaneous amount of pollutant emissions and/or the determination of the second consumption profile and/or the determination of the second pollutant emission profile can respectively also comprise calculation of the instantaneous consumption or of the instantaneous amount of pollutant emissions or of the consumption profile or of the pollutant emission profile.

According to one embodiment of the invention, a graphics screen is connected to the evaluation unit that displays the first and second consumption profiles and/or the first and second pollutant emission profiles. As a result, the profiles can be displayed in a way that can be read precisely and satisfactorily. The graphics screen is preferably a color screen.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are displayed in any desired schematic drawing and are described in more detail below. Elements that respectively correspond to one another are provided with the same reference signs in all the figures in the drawings:

FIG. 1 depicts a block diagram of a display device according to an embodiment of the invention;

FIG. 2 depicts the display device according with a display of the consumption of operating material and of the emission of pollutants;

FIG. 3 depicts the display device with a display of the consumption of operating material;

FIG. 4 is an enlarged detail of the display according to FIG. 3; and

FIG. 5 depicts a display that corresponds in terms of content to FIG. 3.

### DETAILED DESCRIPTION OF THE PRESENTLY PREFERRED EMBODIMENTS

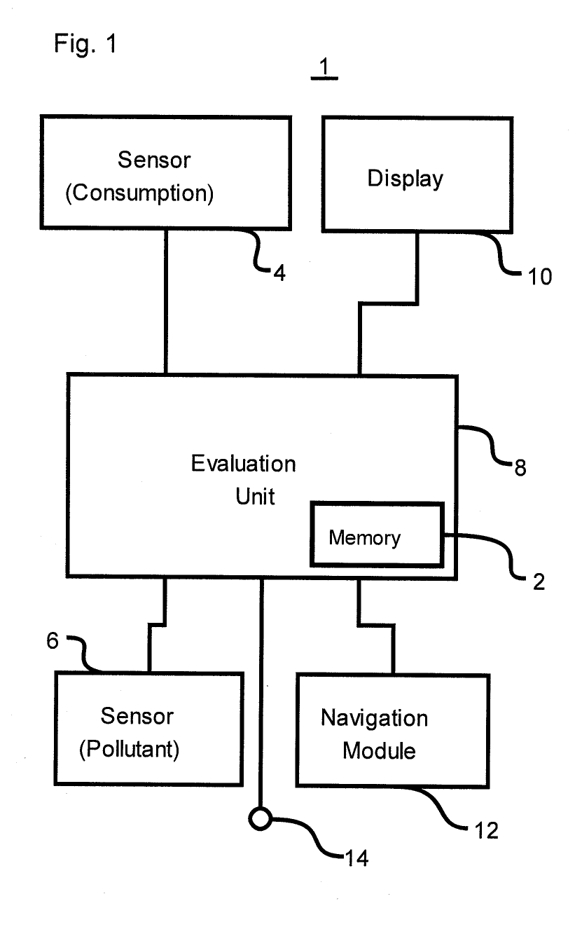

FIG. 1 depicts a display device 1 for a vehicle embodied as a motor vehicle and which has a memory unit 2, a first sensor device 4 for sensing a consumption of an operating material, in particular fuel, and a second sensor device 6 for sensing an instantaneous amount of pollutant emissions, preferably CO₂ emissions, of the vehicle. In a preferred embodiment, the sensors 4, 6 sense instantaneous consumption and emissions. An evaluation unit 8 for determines a consumption profile from the sensed instantaneous consumption and determines a pollutant emission profile from the sensed instantaneous amount of pollutant emissions. In a preferred embodiment, the evaluation unit 8 determines each of the consumption profile and the pollutant emission profile by performing a calculation.

A graphics screen 10, preferably an LCD (Liquid Crystal Display), is coupled to the evaluation unit 8 and displays consumption profiles and pollutant emission profiles. The evaluation unit 8 also has a memory unit 2, and a navigation device 12 that is coupled to the evaluation unit 8, which in this exemplary embodiment also forms a central control unit of the display device 1. It should be noted that memory 2 can be internal or external to the evaluation unit 8. In addition, the evaluation unit 8 is provided with an interface 14 for exporting, in particular, consumption data and/or pollutant emission data to an external device. In one embodiment, navigation data or other relevant date can be input via interface 14. Additionally, navigation data is displayed on screen 10. It should be noted that evaluation unit 8 and navigation unit 14 could be software modules running on a microprocessor.

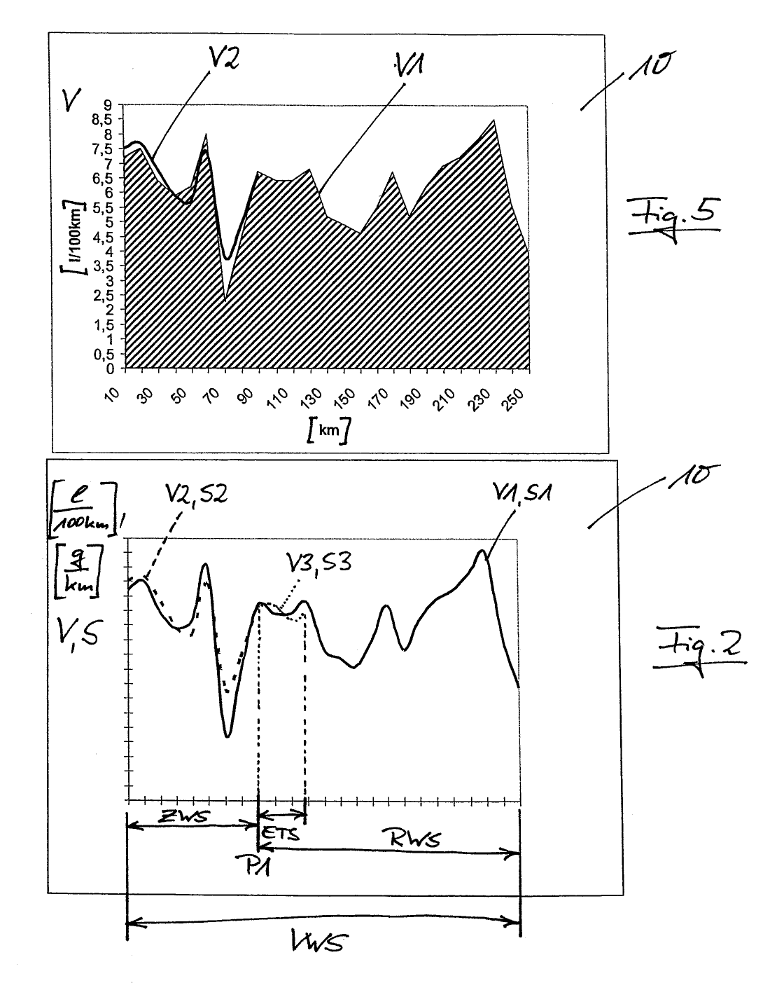

Methods for assisting a driver in driving the vehicle in an environmentally conscious way which are carried out with the display device 1 according to FIG. 1 are explained below in more detail with reference to FIG. 2.

In a method for graphically displaying the consumption of operating material of the vehicle by the display device 1, specifically in this example on the graphics screen 10 of the display device 1, a first consumption profile V1 of a first predetermined instantaneous consumption V over a predefined route VMS is displayed on the display device the same time, a second consumption profile V2 of an actual instantaneous consumption V over a route section ZWS, traveled along by the vehicle, of the predefined route VWS is also displayed on the display device. The instantaneous consumption V is standardized, and given in this example in the unit of 1/100 km. The predefined route is plotted in the unit km. The first consumption profile V1 is preferably displayed as a curve with an unbroken line, and the second consumption profile V2 is preferably displayed as a curve with a dashed line. The vehicle has reached a route point P1 at the time corresponding to the illustration according to FIG. 2.

Furthermore, a third consumption profile V3 of a second predetermined instantaneous consumption V over a first partial route ETS of the residual route section RWS, still to be traveled along by the vehicle, of the predefined route is displayed taking into account the actual instantaneous consumption V over the traveled-along route section ZWS of the predefined route VWS up to the point P1. The third consumption profile V3 is displayed as a curve with a dotted line.

The same graph in FIG. 2 can be used to illustrate a method for graphically displaying the emission of pollutants of the vehicle by the display device 1. In this embodiment, a first pollutant emission profile S1 of a first predetermined instantaneous amount S of pollutant emissions over a predefined route VWS is displayed on the display device and at the same time a second pollutant emission profile S2 of an actual instantaneous amount of pollutant emissions over a route section ZWS, traveled by the vehicle, of the predefined route VWS is displayed on the display device 1. In this case, the graphics screen 10 of the display device 1 displays both S1 and S2. The instantaneous amount S of pollutant emissions is standardized and can be given, for example, in the unit g/km, in particular if CO₂ emissions of the vehicle are considered and displayed as the emission of pollutants of the vehicle. The predefined route is also plotted in the unit km in this example. The first pollutant emission profile S1 is displayed as a curve with an unbroken line, and the second pollutant emission profile S2 is displayed as a curve with a dashed line.

Furthermore, a third pollutant emission profile S3 of a second predetermined instantaneous amount S of pollutant emissions over a first part of the route ETS of the residual route section RWS where the residual route section is the part of the predefined route VWS still to be traveled along by the vehicle, is displayed. The third pollutant emission profile S3 takes into account the actual instantaneous amount S of pollutant emissions over the route section ZWS, traveled along up to the route point P1, of the predefined route VWS. The third pollutant emission profile S3 is displayed as a curve with a dotted line.

In one embodiment, there is a linear relationship between the consumption of operating material and the emission of pollutants. As illustrated in FIG. 2, corresponding consumption and pollutant emission profiles are produced with corresponding scaling of the instantaneous consumption V and instantaneous amount S of pollutant emissions. In other cases, the consumption and pollutant profiles differ from one another. A consumption/route graphic or a pollutant emission/route graphic is displayed on the graphics screen 10.

The first consumption profile V1 and/or the first pollutant emission profile S1 can generally be respectively considered a setpoint value curve, as can also the third consumption profile V3 and/or the third pollutant emission profile S3. In contrast, the second consumption profile V2 and/or the second pollutant emission profile S2 are generally considered to be an actual value curve. Deviations of an actual value curve from an associated setpoint value curve are preferably displayed marked in color.

The display of the curves on the graphics screen is preferably carried out such that an impression corresponding to a 3-D effect is produced. For example, it is possible here that in terms of the impression given to the viewer, that is to say generally the driver of the vehicle, a respective actual value curve is positioned in front of a respective setpoint value curve.

FIG. 3 shows the display according to FIG. 2 for displaying the consumption of an operating material of the vehicle with the first consumption profile V1 and the second consumption profile V2, with scaling.

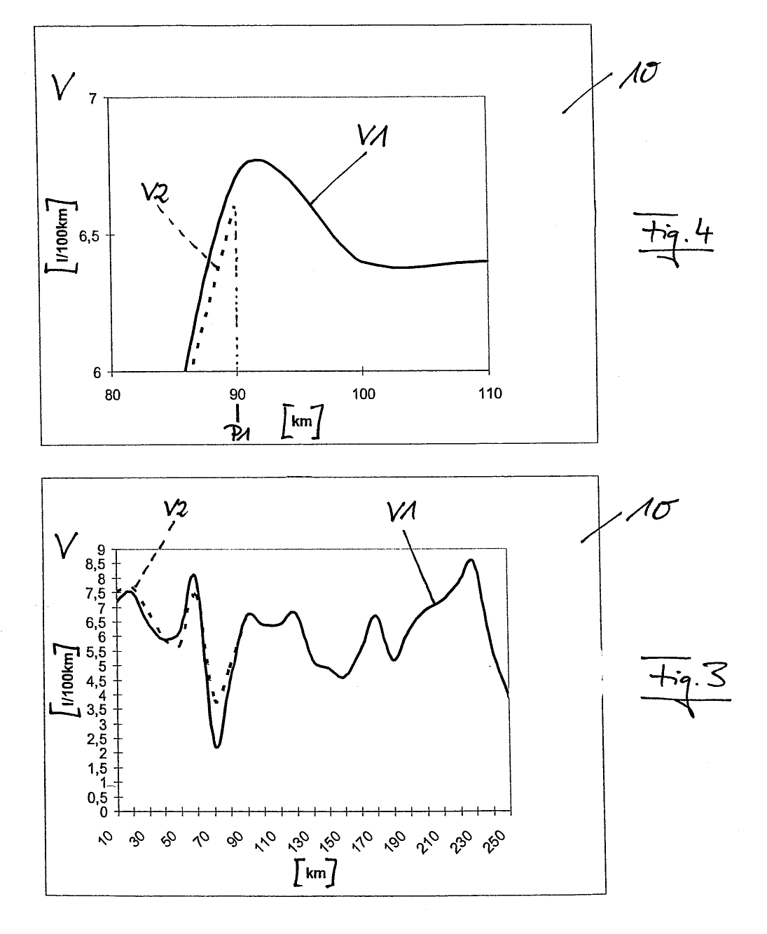

FIG. 4 shows a detail of the display according to FIG. 3, illustrated in an enlarged form, as a result of which the readability for the driver of the vehicle, who is at the route point P1 at the time of viewing, that is to say he has traveled along a route section of 90 km in length in this example, is simplified.

One variant of the display according to FIG. 3 is shown in FIG. 5. Here, the curve of the first consumption profile V1 is not rounded off, and the region underneath this curve is hatched. The second consumption profile V2 is displayed as a curve with an unbroken line.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for graphically displaying fuel consumption of a motor vehicle,
the method comprising:
displaying a first predetermined consumption profile for a predefined route, the first predetermined consumption profile comprising a plurality of predetermined instantaneous consumption values for the predefined route; and
displaying a first actual consumption profile for a traveled portion of the predefined route traveled by the vehicle, the first actual consumption profile comprising a plurality of instantaneous consumption values for the traveled portion,
wherein the first predetermined consumption profile and the actual consumption profile are displayed simultaneously.

2. The method for graphically displaying fuel consumption of a motor vehicle according to claim 1, wherein the first predetermined consumption profile over the predefined route is based at least in part on a selected travel time for the predefined route.

3. The method for graphically displaying fuel consumption of a motor vehicle according to claim 1, further comprising:
displaying a second predetermined consumption profile for at least a portion of a residual route, the residual route representing an untraveled portion of the predefined route,
wherein the second predetermined consumption profile is based at least in part on the first actual consumption profile for the traveled portion of the predefined route.

4. The method for graphically displaying fuel consumption of a motor vehicle according to claim 1, further comprising storing at least the predefined route and the first actual consumption profile in a memory unit.

5. The method for graphically displaying fuel consumption of a motor vehicle of claim 4, the method further comprising:
determining an average consumption over the predefined route, after the entire predefined route has been traveled by the vehicle; and
storing the average consumption in the memory unit.

6. The method for graphically displaying fuel consumption of a motor vehicle according to claim 1, the method further comprising:
acquiring at least one of a vehicle velocity or a gear speed of a vehicle transmission; that is necessary to achieve the first predetermined consumption profile taking into account the actual instantaneous consumption profile.

7. The method for graphically displaying fuel consumption of a motor vehicle according to claim 1, wherein the first predetermined consumption profile is based in part on the plurality of instantaneous consumption values.

8. A method for graphically displaying an amount of pollutant emissions of a motor vehicle, the method comprising:
displaying a first predetermined pollutant emissions profile of a first predetermined instantaneous amount of pollutant emissions over a predefined route;
displaying a first actual pollutant emissions profile of an actual instantaneous amount of pollutant emissions for at least part of the predefined route traveled by the vehicle;
wherein the first predetermined pollutant emissions profile and the actual consumption profile are displayed simultaneously.

9. The method for graphically displaying an amount of pollutant emissions of a motor vehicle according to claim 8, wherein the first predetermined pollutant emissions over the predefined route is based at least in part on a selected travel time for the predefined route.

10. The method for graphically displaying an amount of pollutant emissions of a motor vehicle according to claim 8, further comprising:
displaying a second predetermined pollutant emissions profile for at least a portion of a residual route, the residual route representing an untraveled portion of the predefined route,
wherein the second predetermined pollutant emissions profile is based in part on the first actual pollutant emissions profile for the traveled portion of the predefined route.

11. The method for graphically displaying an amount of pollutant emissions of a motor vehicle according to claim 10, further comprising storing at least the predefined route and the first actual pollutant emissions profile in a memory:

12. The method for graphically displaying an amount of pollutant emissions of a motor vehicle according to claim 11, further comprising:
determining a total of the pollutant emissions over the predefined route, after the entire predefined route has been traveled by the vehicle; and
storing the total pollutant emissions in the memory.

13. The method for graphically displaying an amount of pollutant emissions of a motor vehicle according to claim 12, further comprising:
acquiring at least one of a vehicle velocity or a gear speed of a vehicle transmission that is necessary to achieve the first predetermined pollutant emissions profile taking into account the first actual pollutant emissions profile.

14. The method for graphically displaying fuel consumption of a motor vehicle according to claim 1, further comprising:
displaying a first predetermined pollutant emissions profile of a first predetermined instantaneous amount of pollutant emissions over a predefined route;
displaying a first actual pollutant emissions profile of an actual instantaneous amount of pollutant emissions for at least part of the predefined route traveled by the vehicle;
wherein the first predetermined pollutant emissions profile, the actual pollutant emissions profile, the first predetermined consumption profile, and the actual consumption profile are displayed simultaneously.

15. The method for graphically displaying fuel consumption of a motor vehicle according to claim 6, further comprising transmitting the at least one of a vehicle velocity or a gear speed of a vehicle transmission to a driver of the vehicle.

16. The method for graphically displaying fuel consumption of a motor vehicle according to claim 14, further comprising determining the predefined route using a navigation device.

17. The method for graphically displaying fuel consumption of a motor vehicle according to claim 14, further comprising determining at least one of the predefined route and the first actual consumption profile by recording the at least one of the predefined route and first actual consumption profile when the vehicle travels along the predefined route.

18. The method for graphically displaying fuel consumption of a motor vehicle according to claim 15, further comprising:
inputting the acquired vehicle velocity to a velocity control system; and
controlling the velocity of the vehicle by the velocity control system based at least in part on the acquired emission velocity.

19. A display device for a motor vehicle comprising:
a memory unit coupled to an evaluation unit in which at least one of a first predetermined consumption profile and a first predetermined pollutant emissions profile is stored;
at least one of a first sensor coupled to the evaluation unit for sensing actual consumption and a second sensor coupled to the evaluation unit for sensing actual pollutant emissions; and
the evaluation unit for determining at least one of a second predetermined consumption profile based in part on the actual consumption and the first predetermined consumption profile and for determining a second pollutant emission profile based in part on the actual pollutant emissions and the first predetermined pollutant emissions profile.

20. The display device for a motor vehicle, according to claim 19, wherein the display unit comprises a graphics screen configured to display at least one of the first and second consumption profiles and the first and second pollutant emission profiles simultaneously.
